(19) United States
(12) Patent Application Publication
(10) Pub. No.: US 2024/0135917 A1
(43) Pub. Date: Apr. 25, 2024

(54) Transmitting A Message To One Or More Participant Devices During A Conference

(71) Applicant: Zoom Video Communications, Inc., San Jose, CA (US)

(72) Inventor: Nick Swerdlow, Santa Clara, CA (US)

(73) Assignee: Zoom Video Communications, Inc., San Jose, CA (US)

(21) Appl. No.: 17/972,938

(22) Filed: Oct. 24, 2022

(51) Int. Cl. G10L 13/08; G10L 17/22; H04L 12/18

(52) U.S. Cl. CPC G10L 13/08; G10L 17/22; H04L 12/1822

(57) ABSTRACT

A system may receive, from a computing device that is not connected to a conference to which one or more participant devices are connected, a message including text entered by a user of the computing device. The system may determine a permission for enabling communications between the computing device and the one or more participant devices by authenticating a credential associated with the computing device. The system may transmit, based on the permission, the message to the one or more participant devices during the conference. In some implementations, the system may invoke speech synthesis software during the conference to produce machine-generated speech representative of the message. The speech synthesis software may use a spoken voice model of the user, generated using recorded voice samples of the user, to produce the machine-generated speech.

### FIELD

This disclosure relates generally to video conferencing and, more specifically, to transmitting a message to one or more participant devices during a conference.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for transmitting a message to one or more participant devices during a conference.

FIG. 5 is a block diagram of an example of a system using security software for transmitting a message to one or more participant devices during a conference.

FIG. 6 is a block diagram of an example of a system using speech synthesis software to produce machine-generated speech using a voice model.

FIG. 7 is an illustration of an example of a graphical user interface (GUI) for a computing device to send a message to one or more participant devices during a conference.

FIG. 8 is an illustration of an example of a GUI for transmitting a message to one or more participant devices during a conference.

FIG. 9 is a flowchart of an example of a technique for transmitting a message to one or more participant devices during a conference.

FIG. 10 is a flowchart of an example of a technique for invoking speech synthesis software to transmit a message to one or more participant devices during a conference.

### DETAILED DESCRIPTION OF THE DRAWINGS

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

Conferencing software, such as that of a conventional UCaaS platform, generally enables participants of a conference (e.g., a phone or video conference) to communicate with one another through devices that are connected to the conference. For a device to join the conference, the device may be required to use a particular hyperlink or access code that is generated by the conferencing software. In some cases, encryption and/or network security may be used to protect the conference from unauthorized intrusion by devices that are not connected to the conference. For example, for a conference between employees of a company, the encryption and/or network security may limit access to the conference to employees of the company while preventing non-employees from joining the conference. However, it may be desirable at times for a device that is not connected to the conference to send a message to the devices that are connected to the conference. For example, if an invited participant is running late to a conference that has already begun, the invited participant may want to send a brief message to other participants of the conference to indicate that they will be late. However, the encryption and/or network security may prevent the message from being delivered within the conference modality (i.e., using the conferencing software implementing the conference) in order to protect the conference from intrusion. In such a case, the invited participant may need to use a different modality and thus a different software service to send the message, which may result in the intended recipients not receiving it or such receipt being delayed. Additionally, even if the message could reach the participants through the conference modality, the message may be limited to an impersonal communication (e.g., simple text) due to the invited participant's absence from the conference. For example, sending a short message service (SMS) text message to indicate that the invited participant is running late may be inadequate for expressing the invited participant's regrets.

Implementations of this disclosure address problems such as these by configuring, in connection with a conference, access controls selectively enabling computing devices that are not connected to the conference to communicate messages to devices that are connected to the conference. A device can execute conferencing software (e.g., client-side phone or video conferencing software) to connect one or more participant devices (e.g., used by one or more invited participants) to a conference. The device can receive a message (e.g., an SMS text message, chat message, email, or calendar invite) from a computing device (e.g., used by another invited participant) that is not connected to the conference. For example, the device can receive the message from the computing device before the user of the computing device is able to join the conference. The message may include text entered by the user of the computing device. The device can then determine a permission for the computing device to communicate the message to the one or more participant devices during the conference without the computing device connecting to the conference (e.g., without the user of the computing device joining the conference). The device can determine the permission by authenticating a credential (e.g., a digital credential, such as a phone number, an internet protocol (IP) address, or a personal identification number (PIN), or a non-digital credential, such as a driver's license or access card). The device can then transmit the message, based on the permission, to participant devices connected to the conference during the conference without the computing device itself first connecting to the conference.

In some implementations, speech synthesis software may be invoked during the conference to produce machine-generated speech representative of the message. The speech synthesis software may use a spoken voice model of the user, generated using recorded voice samples of the user (e.g., from one or more previous conferences and/or using offline training), to produce the machine-generated speech in the voice (e.g., a cadence, inflection, volume, and/or direction of the speech, such as corresponding to one or more of sound, tone, pitch, phrasing, pacing, and/or accent characteristics) of the user. In some implementations, the device can detect a color or a highlight of at least a portion of the text, and may produce the machine-generated speech representative of the message where the speech changes inflection based on the color or the highlight (e.g., in which the color or highlight may impart emotion to one or more words conveyed by the speech). In some implementations, the device can communicate the message as a chat message within the conference. As a result, the computing device may be treated as though it were temporarily a part of the conference with limited access for sending messages to participants in the conference.

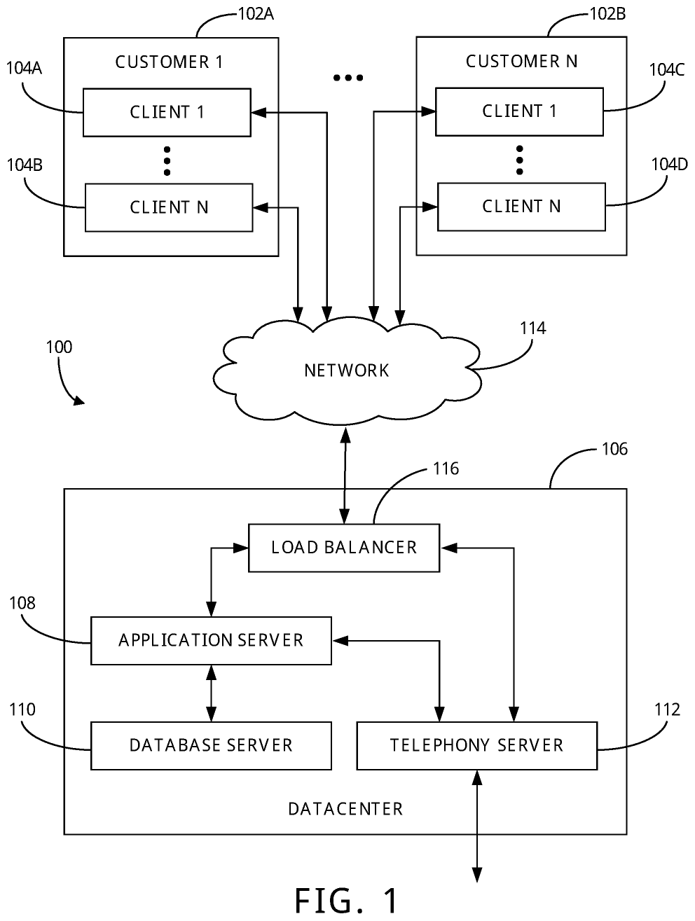

To describe some implementations in greater detail, reference is first made to examples of hardware and software structures used to implement a system for transmitting a message to one or more participant devices during a conference. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over Internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106. For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

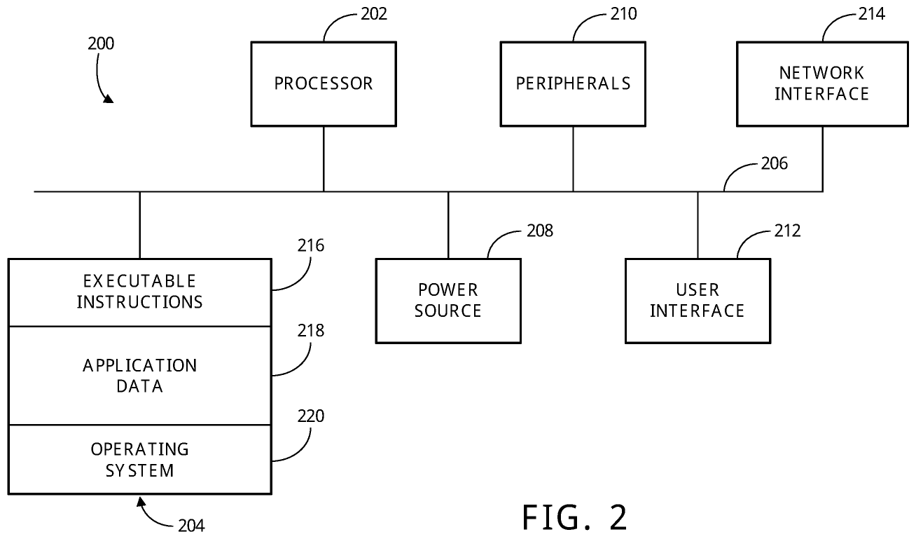

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR DRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

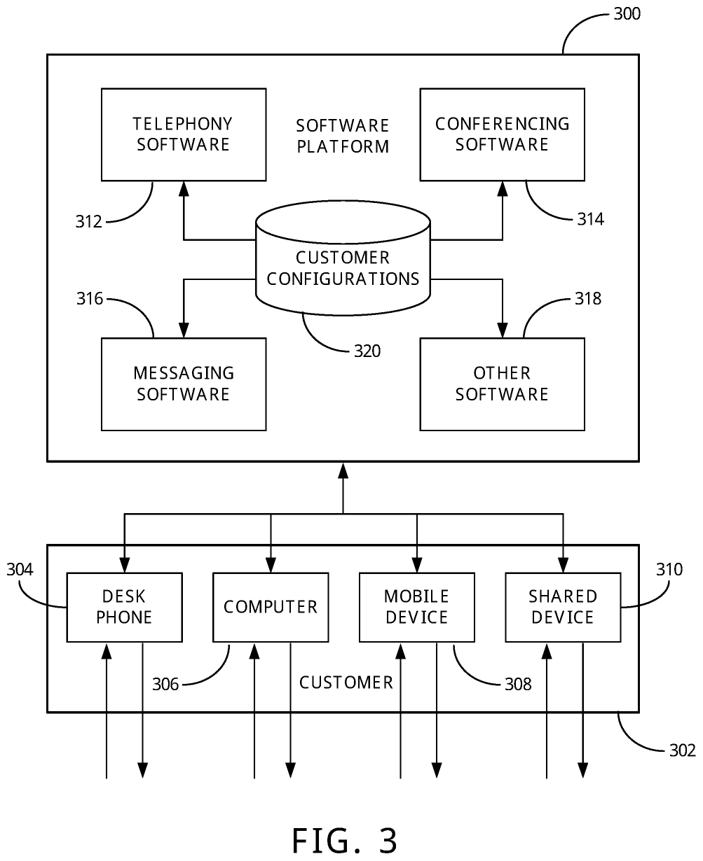

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include security software and/or speech synthesis software, including for transmitting a message to one or more participant devices during a conference. In some such cases, the conferencing software 314 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some, or all, of the software 312 through 318 may be combined into a single software application run on clients of the customer, such as one or more of the clients 304 through 310.

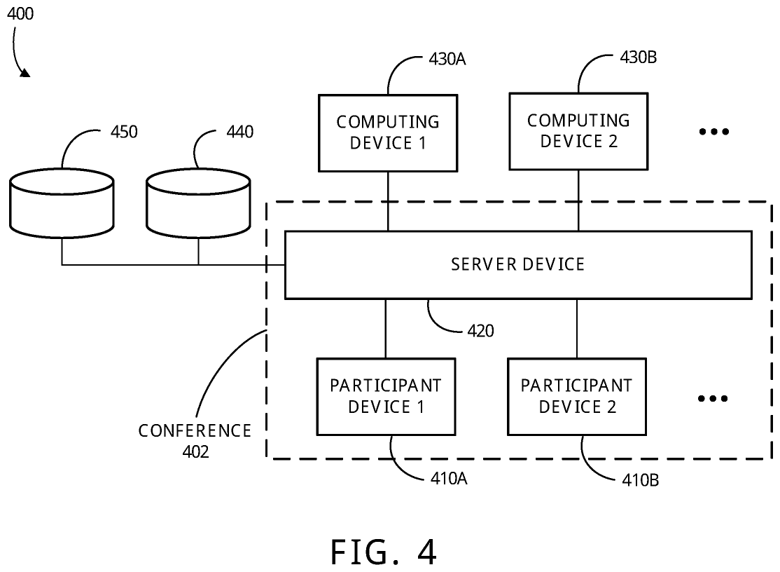

FIG. 4 is a block diagram of an example of a system 400 for transmitting a message to one or more participant devices during a conference 402 (e.g., a phone or video conference). The system 400 may include one or more participant devices that can be used by participants of the conference 402, such as a participant device 410A used by a first participant and a participant device 410B used by a second participant. For example, each of the participant devices 410A and 410B may be a client device such as one of the clients 104A through 104D shown in FIG. 1 or 304 through 310 shown in FIG. 3. Although two participant devices 410A and 410B are shown and described by example, other numbers of participant devices may be used with the system 400. A participant device such as the participant devices 410A and 410B may execute software (e.g., client-side conferencing software, which could, for example, be via a client application or a web application used to connect to a conference implemented using server-side conferencing software, such as the telephony software 312 or the conferencing software 314 shown in FIG. 3) and may connect to a server device 420. The server device 420 may execute software (e.g., server-side conferencing software, such as the telephony software 312 or the conferencing software 314) to support a phone or video conference between participants using the participant devices 410A and 410B. For example, the server device 420 could be a server at the datacenter 106 shown in FIG. 1, such as the application server 108 or the telephony server 112.

The participant devices 410A and 410B may be computing devices that include at least a processor and a memory. The participant devices 410A and 410B may join the conference 402, for example, by using a particular hyperlink or access code that is generated by the conferencing software. The participant devices 410A and 410B may become participant devices (e.g., as opposed to computing devices) when they join the conference 402.

Encryption and/or network security may be used to protect the conference 402 from unauthorized intrusion by computing devices that are not connected to the conference 402. For example, the system 400 may include one or more other computing devices that are not connected to the conference 402, such as a computing device 430A used by a first user and a computing device 430B used by a second user. Although two computing devices 430A and 430B are shown and described by example, other numbers of computing devices may be used with the system 400. While the computing devices 430A and 430B are not connected to the conference 402, it may nevertheless be desirable for them to send messages to the devices that are connected to the conference (e.g., the participant devices 410A and 410B). For example, if the first user using the computing device 430A is an invited participant of the conference 402, and the first user is running late, it may be desirable for the first user to send a message to other participants of the conference 402 (e.g., the first and second participants using the participant devices 410A and 410B) to indicate that the first user will be late.

To enable communicating messages in the conference 402 from a computing device (e.g., the computing device 430A) that is not connected to the conference 402, the server device 420 may invoke security software (e.g., server-side security software, such as the other software 318). Using the security software, the server device 420 can receive a message from the computing device, such as a SMS text message, a chat message, an email, or a calendar invite. The message can be routed from the computing device to the server device, for example, via a phone number (e.g., for sending the SMS text message) or a hyperlink or web address (e.g., for sending the chat message, the email, or the calendar invite) associated with the conference 402. In some implementations, the message may be dictated by a user of the computing device (e.g., the first user using the computing device 430A) calling the phone number associated with the conference. The message can then be received by the server device 420 supporting the conference 402 before the computing device joins the conference 402. The message may include text entered by the user (e.g., text associated with the SMS text message, chat message, email, or calendar invite).

The server device 420 can then determine a permission for the computing device (e.g., the computing device 430A) to communicate the message to the participant devices 410A and 410B during the conference 402 without the computing device connecting to the conference 402 (e.g., without the first user using the computing device 430A joining the conference 402). For example, the server device 420 can determine the permission by accessing one or more records stored in a data structure 440 to authenticate a credential associated with the computing device (e.g., a digital credential, such as a phone number, an IP address, or a PIN, or a non-digital credential, such as a driver's license or access card associated with the user). The server device 420 can then transmit the message, based on the permission, to the participant devices 410A and 410B during the conference 402 without the computing device connecting to the conference 402. As a result, the computing device (e.g., the computing device 430A) may be treated as though it were temporarily a part of the conference 402 with limited access for sending messages to participants in the conference 402 (e.g., the first and second participants using the participant devices 410A and 410B).

In some implementations, the server device 420 may invoke speech synthesis software during the conference 402 to produce machine-generated speech representative of the message. For example, the server device 420 may invoke the speech synthesis software (e.g., server-side speech synthesis software, such as the other software 318). The speech synthesis software may use a spoken voice model of a user stored in a data structure 450 (e.g., a voice model of the first user, using the computing device 430A), so that the machine-generated speech sounds like the user speaking to the participants. The spoken voice model can be generated using recorded voice samples of the user, such as from one or more previous conferences and/or using offline training. As a result, the user of the computing device (e.g., the first user using the computing device 430A) can temporarily have a voice in the conference 402.

In some implementations, the server device 420 can also transmit the message, based on the permission, to one or more computing devices that are not connected to the conference 402. For example, in addition to transmitting the message to the participant devices 410A and 410B that are connected to the conference 402, the server device 420 can further transmit the message, based on the same permission used for transmitting the message to the participant devices 410A and 410B (e.g., a first permission) or a different permission (e.g., a second permission), to the computing device 430B that is not connected to the conference 402 (e.g., the second permission being an authorization for the computing device 430B). This may be useful, for example, to keep other invited participants that have not yet joined the conference (e.g., the second user of the computing device 430B) informed of events related to the conference, such as to alert the second user that the first user is also running late.

In some implementations, the server device 420 can transmit a second message back to the computing device (e.g., the computing device 430A). For example, having established the permission for the computing device to communicate with participant devices of the conference without the computing device connecting to the conference, a participant device (e.g., participant device 410A) can then send a message to the computing device (e.g., with or without including other participant devices, such as participant device 410B). For example, the server device 420 can transmit the message back to the computing device as a reply SMS text message, a reply chat message, or a reply email.

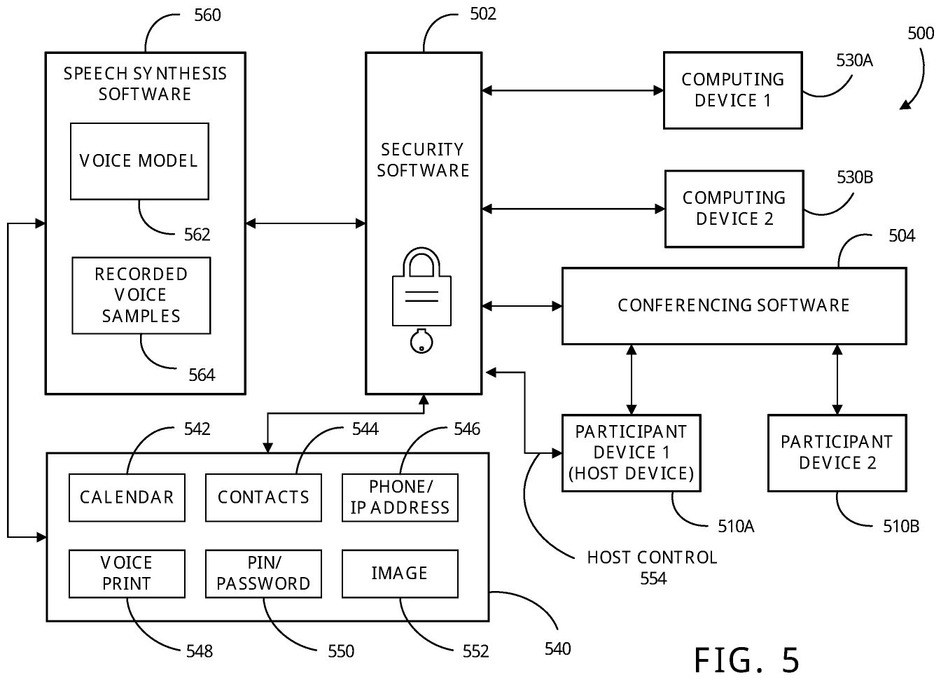

FIG. 5 is a block diagram of an example of a system 500 using security software 502 for transmitting a message to one or more participant devices during a conference (e.g., a phone or video conference, such as the conference 402). For example, the server device 420 shown in FIG. 4 may use the security software 502 to enable communicating messages in a conference configured by conferencing software 504 (e.g., the client-side conferencing software and/or the server-side conferencing software). The security software 502 may enable communicating the messages from one or more computing devices that are not connected to the conference, such as one of the computing devices 530A and 530B, to one or more participant devices that are connected to the conference, such as the participant devices 510A and 510B. The computing devices 530A and 530B may be like the computing devices 430A and 430B shown in FIG. 4, and the participant devices 510A and 510B may be like the participant devices 410A and 410B, shown in FIG. 4.

The security software 502 may include a security layer configured to limit access to the conference. For example, the security software 502 may implement encryption and/or network security used to protect the conference from unauthorized intrusion by computing devices that are not connected to the conference. This may initially include the computing devices 530A and 530B. However, to selectively enable communicating messages in the conference from a computing device that is not connected to the conference, the security software 502 can initially receive a message from the computing device (e.g., the computing device 530A). For example, the security software 502 could receive an SMS text message, chat message, email, or calendar invite from a user using the computing device. In some implementations, the security software 502 could receive a dictated message from a user using the computing device. The security software 502 can receive the message before the computing device is connected to the conference (e.g., while the computing device is not yet a participant device).

The security software 502 can then determine a permission for the computing device (e.g., the computing device 430A) to communicate the message to participant devices in the conference (e.g., the participant devices 510A and 510B) without the computing device connecting to the conference (e.g., without the first user using the computing device 530A joining the conference 402). To determine the permission, the security software 502 may access one or more records in a data structure 540, like the data structure 440 shown in FIG. 4, to authenticate a credential associated with the computing device. In some cases, the credential could be a digital credential, such as a phone number, an IP address, a PIN, a password, or login information. In some cases, the credential could be a non-digital credential, such as a driver's license or access card associated with the user. For example, the non-digital credential could provide identifying information, such as by radio frequency identification (RFID) or near-field communication (NFC), which could be transmitted with the message to the security software 502. Based on the particular credential that is transmitted from the computing device, the security software 502 can access one or more records in the data structure 540 to verify or authenticate the credential. For example, the security software 502 can access records including calendars 542, contacts 544, authorized phone numbers/IP addresses 546, authorized voice prints 548, authorized PINs/passwords 550, and/or authorized images 552 to verify the credential.

In one example, the security software 502 can determine a phone number (e.g., via caller ID) or IP address (e.g., from where the message is sent) that is associated with the computing device when receiving the message. The security software 502 can then access the authorized phone numbers/IP addresses 546 record to determine the authorized phone numbers or IP addresses for the conference. In some implementations, the security software 502 may determine the authorized phone numbers or IP addresses for a conference by accessing the calendars 542 of users (e.g., calendar invites) to determine users that are invited participants to the particular conference. The security software 502 can further access the contacts 544 (e.g., a digital address book) of users to determine contact information (e.g., phone numbers or IP addresses) of the invited participants to determine the authorized phone numbers/IP addresses 546 record. The security software 502 can compare the phone number or IP address associated with the computing device to the authorized phone numbers or IP addresses in the authorized phone numbers/IP addresses 546 record to verify or authenticate the phone number or IP address. Based on the authentication, the security software 502 can determine the permission for the computing device to transmit the message during the conference. In some implementations, the security software 502 can disable verifying or authenticating by a phone number or IP address, such as when determining a risk associated with aliasing or spoofing of the phone number or IP address.

In another example, the security software 502 can receive a PIN or password from the computing device when receiving the message. For example, the PIN or password may be submitted by a user entering text for the PIN or password when sending the message. The security software 502 can access the authorized PINs/passwords 550 record to determine authorized PINs or passwords for the conference. The security software 502 can then compare the PIN or password from the computing device to the authorized PINs or passwords in the PINs/passwords 550 record to verify or authenticate the PIN or password. Based on the authentication, the security software 502 can determine the permission for the computing device to transmit the message during the conference. In this example, the user advantageously does not have to limit themselves to using their own phone or computing device (e.g., associated with their contact information in the contacts 544 record) when sending the message.

In another example, the security software 502 can receive a keyword spoken by a user (e.g., using a microphone of the computing device) when receiving the message. The security software 502 can access the authorized PINs/passwords 550 record to determine authorized keywords for the conference. Additionally, or alternatively, the security software 502 can access the authorized voice prints 548 record to determine authorized voice prints (e.g., recorded voice samples) of invited participants to the conference. In some implementations, invited participants may be determined by accessing the calendars 542 of users (e.g., calendar invites). The security software 502 can compare the keyword from the computing device to authorized keywords in the PINs/passwords 550 record to verify or authenticate the keyword. Additionally, or alternatively, the security software 502 can compare a sampled voice print of the user speaking the keyword to the authorized voice prints 548 to verify or authenticate the voice of the user as an invited participant. Based on the authentication, the security software 502 can determine the permission for the computing device to transmit the message during the conference. Once again, in this example, the user advantageously does not have to limit themselves to using their own phone or computing device when sending the message.

In another example, the security software 502 can receive an image of a user (e.g., using a camera of the computing device) when receiving the message. The security software 502 can access the authorized images 552 record to determine images of authorized or invited participants to the conference. In some implementations, invited participants may be determined by accessing the calendars 542 of users (e.g., calendar invites). The security software 502 can compare the image of the user sent via the computing device to the images of authorized or invited participants in the authorized images 552 record to verify or authenticate the image of the user as corresponding to an invited participant. Based on the authentication, the security software 502 can determine the permission for the computing device to transmit the message during the conference.

The security software 502 can transmit the message, based on the permission, to the participant devices (e.g., the participant devices 510A and 510B) during the conference without the computing device (e.g., the computing device 530A) connecting to the conference. The message could be communicated, for example, as a chat message within the conference. In some implementations, a host device connected to the conference can control the permissions being granted or denied to one or more computing devices. For example, a participant using participant device 510A may also be a host of the conference (e.g., the participant device 510A could also be a host device). The host device may be configured with a host control 554 for controlling permissions that are granted or denied to computing devices during the conference. The host controls may include, for example, selectively enabling whether a computing device can transmit a message during the conference (e.g., authorizing the computing device 530A, while not authorizing or de-authorizing the computing device 530B), and selectively enabling how a message can be transmitted during the conference (e.g., communicating the message as a chat message, or allowing speech synthesis software 560 to be invoked to produce machine-generated speech). Thus, the security software 502 may receive input from the host device, via the host control 554, for controlling the permissions.

In some implementations, the security software 502 can selectively transmit or deliver the message to one or more of the participant devices, but not one or more other participant devices. For example, transmission of the message could be limited to the participant device 510A (e.g., which could be based on the participant device 510A being a host device), so that other participants, such as the participant device 510B, do not receive the message. The message could be selectively transmitted to the one or more participant devices privately within the conference (e.g., as a private message to the one or more participant devices, such as an in meeting chat targeting the one or more participant devices) or outside of the conference (e.g., an instant message targeting the one or more participant devices).

In some implementations, the security software 502 can transmit the message, based on a second permission, to a second computing device that is not connected to the conference. For example, in addition to transmitting the message from the computing device 530A to the participant devices 510A and 510B based on the permission, the security software 502 can further transmit the message to the computing device 530B (e.g., which is not connected to the conference 402) based on a second permission associated with the computing device 530B. To determine the second permission, the security software 502 can access the one or more records in the data structure 540 to verify or authenticate a second credential associated with the computing device 530B. Based on the authentication, the security software 502 can determine the second permission for transmitting the message to the computing device 530B.

In some implementations, the security software 502 can invoke the speech synthesis software 560 during the conference to produce machine-generated speech representative of the message. The speech synthesis software 560 may use a spoken voice model 562 of a user (e.g., the first user using the computing device 530A) stored in a data structure like the data structure 450 shown in FIG. 4. Accessing the spoken voice model 562 may enable the speech synthesis software 560 to produce machine-generated speech that sounds like the user speaking to the participants. For example, the spoken voice model 562 may be generated using recorded voice samples 564 of the user, such as from one or more previous conferences and/or from offline training.

In some implementations, the message may be transmitted with metadata generated by the computing device (e.g., the computing device 530A). The metadata could include, for example, geolocation information generated by the computing device. The metadata (e.g., the geolocation information) may be transmitted to the participants that are connected to the conference (e.g., the participant devices 510A and 510B) with the message. The metadata may permit, for example, the participants to obtain additional information from the user of the computing device, such as a precise location of the user (e.g., using a global positioning system implemented by the computing device) to estimate how late the user may be for attending the conference.

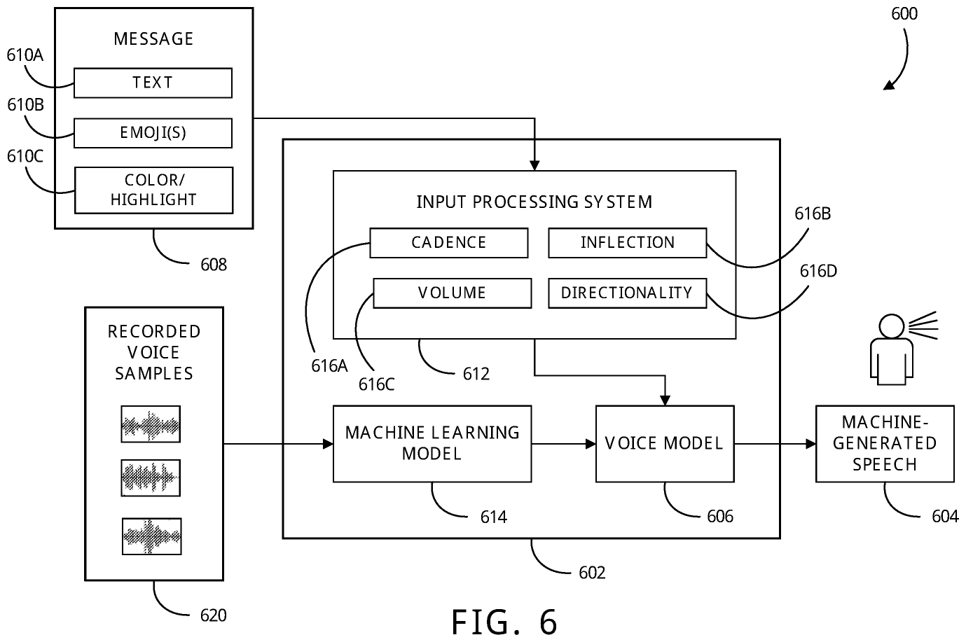

FIG. 6 is a block diagram of an example of a system 600 using speech synthesis software 602 to produce machine-generated speech 604 using a voice model 606. For example, the speech synthesis software 602 and the voice model 606 may be like the speech synthesis software 560 and the voice model 562 shown in FIG. 5. A server device like the server device 420 shown in FIG. 4 could invoke the speech synthesis software 602. In some cases, the server device may invoke the speech synthesis software 602 to implement a text-to-speech engine.

The speech synthesis software 602 may receive a message 608 from a computing device (e.g., the computing device 430A, or the computing device 530A). The message 608 may include a payload, such as one or more of text 610A, emojis/GIFs 610B, and color/highlight 610C. A GIF may refer to a graphics interchange format (GIF) representation, and in some cases, may include a meme (e.g., the meme could be pasted into the SMS message). A user may provide the message 608, for example, by typing the input via a user interface (e.g., the user interface 212, such as a keyboard or touchscreen) of a computing device, such as by sending an SMS text message, chat message, email, or calendar invite. The user may provide the message 608 during a conference, without joining the conference, so that the participants of the conference (e.g., participants using participant devices 410A and 410B or participant devices 510A and 510B) can hear the message 608 in the voice of the user. In some implementations, the user may provide the message 608 via a wearable electronic device or a virtual reality (VR) device.

The speech synthesis software 602 may invoke an input processing system 612, a machine learning model 614, and the voice model 606. The input processing system 612 may receive the payload (e.g., the one or more of text 610A, emojis/GIFs 610B, and color/highlight 610C) from the message 608. The speech synthesis software 602 may process the payload to detect the text 610A, the emojis/GIFs 610B, and the color/highlight 610C as submitted by the user via the computing device. Based on the message 608, the input processing system 612 may determine parameters corresponding to one or more of a cadence 616A, an inflection 616B, a volume 616C, and a directionality 616D for configuring the machine-generated speech 604. The cadence 616A may control a rate or speed at which the machine-generated speech 604 is output. For example, text comprising all capital letters, color, highlight or certain emojis or GIFs, could cause the cadence 616A to change, such that the machine-generated speech 604 is output at a faster or slower rate (e.g., simulating speaking quickly or slowly). The inflection 616B (e.g., tone or intonation) may control an emphasis on certain words when the machine-generated speech 604 is output. For example, text comprising all capital letters, italicized, bold, or underlined words, or color or highlight of certain words, or emojis or GIFs, could cause the inflection 616B to change, such that the machine-generated speech 604 emphasizes the certain words when output (e.g., simulating speaking emphatically). The volume 616C may control an energy level at which the machine-generated speech 604 is output. For example, text comprising all capital letters or exclamation marks, color, highlight, or certain emojis or GIFs, could cause the volume 616C to change, such that the machine-generated speech 604 is output at a higher or lower volume (e.g., simulating speaking loudly or quietly). The directionality 616D may control a direction in a three-dimensional spatial environment in which the machine-generated speech 604 is output. For example, text comprising arrows, color, highlight, or certain emojis or GIFs, could cause the directionality 616D to change, such that the machine-generated speech 604 is output by a greater amount in a particular direction (e.g., simulating speaking to participants on one side of a room while facing away from participants on another side of the room). The input processing system 612 may apply the parameters to the voice model 606 to affect the machine-generated speech 604 that is produced. Thus, the text 610A, the emojis/GIFs 610B, and the color/highlight 610C can generate parameters affecting the machine-generated speech 604. In some implementations, certain emojis/GIFs and/or memes may map to parameters that may be predetermined in a library for affecting the machine-generated speech 604.

The speech synthesis software 602 may use the machine learning model 614 to configure the voice model 606. The machine learning model 614 may configure the voice model 606 so that the machine-generated speech 604 sounds like the voice of the user or a voice chosen by the user to a human observer. The machine learning model 614 may be trained using a training data set including data samples corresponding to recorded voice samples 620 of the user (e.g., audio snippets of the user's own voice) or voice samples chosen by the user (e.g., audio snippets of a chosen voice, which might not be the user's own voice, but rather a voice selected by the user). The training data set can enable the machine learning model 614 to learn patterns, such as the cadence, inflection, volume, and/or directionality of a user's speech or chosen speech, so that the machine-generated speech 604 sounds like the voice of the user or voice chosen by the user. The training can be periodic, such as by updating the machine learning model 614 on a discrete time interval basis (e.g., once per week or month), or otherwise. The training data set may derive from multiple recorded voice samples 620 (e.g., shorter audio snippets) or may be specific to a particular one of the recorded voice samples 620 (e.g., a longer audio snippet). The recorded voice samples 620 may be obtained by the speech synthesis software 602 in different ways. In one example, the recorded voice samples 620 may be obtained from recordings of one or more past conferences in which the user is speaking. In another example, the recorded voice samples 620 may be obtained during a conference for later use in the same conference or another conference. In yet another example, the recorded voice samples 620 may be obtained by offline training, such as by the speech synthesis software 602 requesting the user to speak certain words and capturing audio data corresponding to the words that are spoken. The training data set in any such case may omit certain data samples that are determined to be outliers, such as noise or recorded voice samples of other users. The machine learning model 614 may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other machine learning model. In some implementations, the machine learning model 614 may learn the cadence, the inflection, the volume, and/or the directionality of the user for configuring the machine-generated speech 604 based on the parameters corresponding to the cadence 616A, the inflection 616B, the volume 616C, and the directionality 616D.

Thus, the speech synthesis software 602 may use the voice model 606 to produce the machine-generated speech 604. The voice model 606 may configure the machine-generated speech 604 to sound like the voice of the user or voice chosen by the user (e.g., a cadence, inflection, volume, and/or direction of the speech, such as corresponding to one or more of sound, tone, pitch, phrasing, pacing, and/or accent characteristics) to a human observer, such as by training the machine learning model 614 to provide such configuration of the voice model 606. The voice model 606 may configure the machine-generated speech 604 to have a cadence, an inflection, a volume, and/or a directionality based on the parameters from the input processing system 612. As a result, the machine-generated speech 604 may comprise audio representative of the message 608 (e.g., audio representative of the text, emojis, GIFs, color, or highlight, sounding like the user has spoken aloud what the user has submitted via typing).

The server device (e.g., the server device 420), using the speech synthesis software 602, may output the machine-generated speech 604 to participant devices that are connected to the conference (e.g., the participant devices 410A and 410B or participant devices 510A and 510B). In some implementations, the speech synthesis software 602 may output the machine-generated speech 604 to computing devices that are not connected to the conference (e.g., the computing device 430B or the computing device 530B). The machine-generated speech 604 may be output to the participant devices during the conference to transmit the message 608 (e.g., for the participants using the participant devices to hear during the conference). For example, if the message 608 was an SMS text message or a chat message, the content of the SMS text message or a chat message could be read aloud by the machine-generated speech 604 in the user's voice, or a voice chosen by the user. In another example, if the message 608 was an email, the recipients, date, title, and/or contents of the email could be read aloud by the machine-generated speech 604 in the user's voice, or a voice chosen by the user. In a further example, if the message 608 was a calendar invite, the recipients, date, title, and/or contents of the calendar invite (e.g., an agenda for the conference) could be read aloud by the machine-generated speech 604 in the user's voice, or a voice chosen by the user.

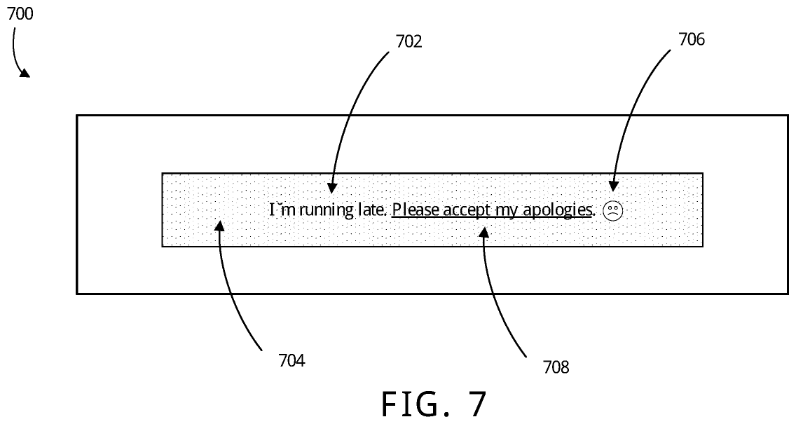

FIG. 7 is an illustration of an example of a GUI 700 for a computing device to send a message to one or more participant devices during a conference. The GUI 700 may be used to send a message like the message 608 shown in FIG. 6. The GUI 700 could be configured for display at a computing device like the computing device 430A shown in FIG. 4 or the computing device 530A shown in FIG. 5. In some implementations, the GUI 700 could be displayed by a wearable electronic device or a VR device. A user may send the message, for example, by typing text via the GUI 700 (e.g., the user interface 212, such as a keyboard or touchscreen), such as for sending an SMS text message, chat message, email, or calendar invite. In some implementations, the user may dictate the text via a microphone of the computing device.

The message may include one or more of text, emojis/GIFs, and color/highlight. For example, the message could include text 702 indicating: “I'm running late. Please accept my apologies.” The speech synthesis software (e.g., the speech synthesis software 602) may detect the text 702 and produce machine-generated speech (e.g., the machine-generated speech 604) based on the text 702. The machine-generated speech may be configured based on a default cadence, inflection, volume, and directionality.

The message may also include a highlight 704 of certain portions of the text 702, such as a blue highlight of all of the text 702. The speech synthesis software may detect the highlight 704 and change one or more of the cadence, the inflection, the volume, or the directionality for the portions of the text 702, based on the highlight 704, in the machine-generated speech. The message may also include an emoji 706, such as a frown face. The speech synthesis software may detect the emoji 706 and further change one or more of the cadence, the inflection, the volume, or the directionality for associated portions of the text 702, based on the emoji 706, in the machine-generated speech. The message may also include a text emphasis 708, such as italicized, bold, or underlined words, or words with an alternative font color, such as the “Please accept my apologies” portion of the text 702. The speech synthesis software may detect the text emphasis 708 and further change one or more of the cadence, the inflection, the volume, or the directionality for associated portions of the text 702, based on the text emphasis 708, in the machine-generated speech (e.g., only the “Please accept my apologies” portion). As a result, the machine-generated speech can be constructed in various ways, as configured by the user, to impart emotion to one or more of the words being conveyed, such as disappointment for being late or excitement for the conference.

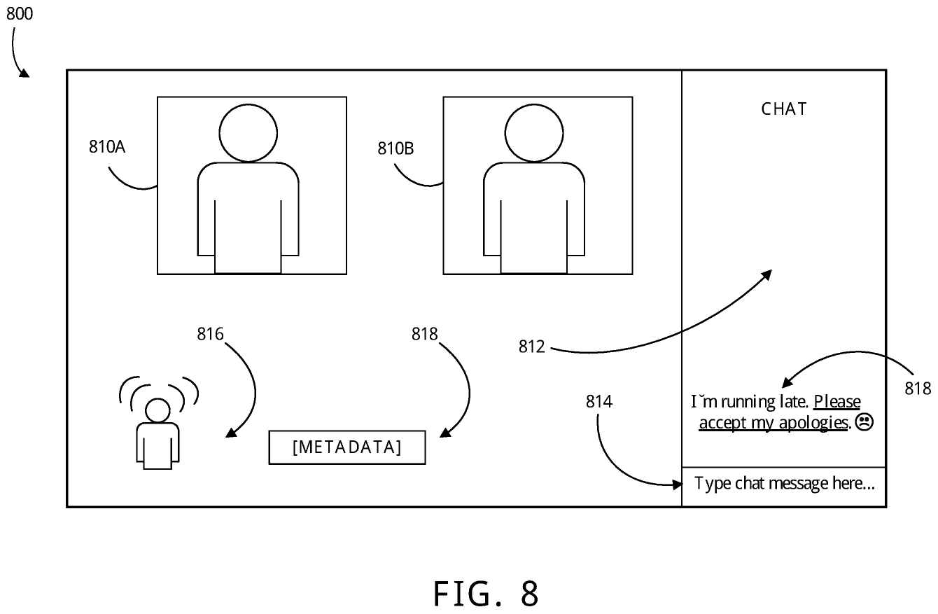

FIG. 8 is an illustration of an example of a GUI 800 for transmitting a message to one or more participant devices during a conference (e.g., a video conference, such as the conference 402). The GUI 800 could be configured for display at an output interface (e.g., the user interface 212) of a participant device during a conference. For example, the GUI 800 could be configured for display at an output interface of the participant devices 410A and 410B shown in FIG. 4, or the participant devices 510A and 510B shown in FIG. 5. The GUI 800 could display user tiles associated with participants of the conference, such as a user tile 810A (e.g., associated with a participant device used by a first participant, like the participant device 410A or the participant device 510) and a user tile 810B (e.g., associated with a participant device used by a second participant, like the participant device 410B or the participant device 510B). The GUI 800 can prevent the display of user tiles associated with users of computing devices that are not connected to the conference (e.g., users that have not joined the conference). For example, the GUI 800 would not display a user tile for users of the computing devices 430A and 430B shown in FIG. 4, or the computing devices 530A and 530B shown in FIG. 5, as those computing devices are not connected to the conference (e.g., they have not joined the conference).

The participants of the conference (e.g., the participants associated with the user tiles 810A and 810B) can communicate with one another during the conference by speaking to one another. In addition, the GUI 800 may display a chat area 812. The chat area 812 may enable the participants of the conference to communicate with one another by sending chat messages. For example, a participant of the conference can type a chat message in a chat input field 814 (e.g., “Type chat message here . . . ”). A history of the chat messages that are communicated during the conference can be graphically shown in the chat area 812.

When security software (e.g., the security software 502) receives a message from a computing device (e.g., the computing device 430A shown in FIG. 4 or the computing device 530A shown in FIG. 5) that is not connected to the conference, and determines a permission for enabling communications between the computing device and the participant devices, the security software may transmit the message to the participant devices during the conference. In some implementations, the security software may transmit the message by communicating the message as a chat message within the conference (e.g., in the chat area 812). For example, the security software may transmit the message entered via the GUI 700 shown in FIG. 7 (e.g., “I'm running late. Please accept my apologies.”), including with the text, emojis/GIFs, and color/highlight as entered by the user (e.g., via the GUI 700). In some implementations, the security software may invoke speech synthesis software (e.g., the speech synthesis software 602) to transmit the message (e.g., the message 608). The speech synthesis software can produce machine-generated speech (e.g., the machine-generated speech 604) representative of the message, which can then be played for the participants of the conference to hear.

In some implementations, an icon 816 may be displayed to the GUI 800 indicating an availability of the message. A participant of the conference can select the icon 816 to access the message during the conference (e.g., display the message in the chat area 812, or play the message for the participants to hear). In some implementations, metadata 818 may be displayed to the GUI 800. The metadata 818 could include, for example, geolocation information generated associated with the user sending the message. The metadata 818 may permit the participants to obtain additional information from the user of the computing device, such as a precise location of the user to estimate how late the user may be for attending the conference.

In some implementations, a participant (e.g., the participant associated with the user tile 810A) can send a second message back to the user of the computing device that sent the original message. For example, having established the permission for enabling communications between the computing device and the participant devices, the participant device can send the second message to the computing device (e.g., with or without including other participants, such as the participant associated with the user tile 810B). In some implementations, the participant can send the second message by typing the second message in the chat area 812 and indicating a recipient of the chat message (e.g., only the user of the computing device, or the user of the computing device and one or more selected participants, or every user for which permission has been established and one or more selected participants or every participant). The server device 420 can then transmit the second message back to the computing device in a manner in which the original message was received, such as by transmitting a reply SMS text message, a reply chat message, or a reply email.

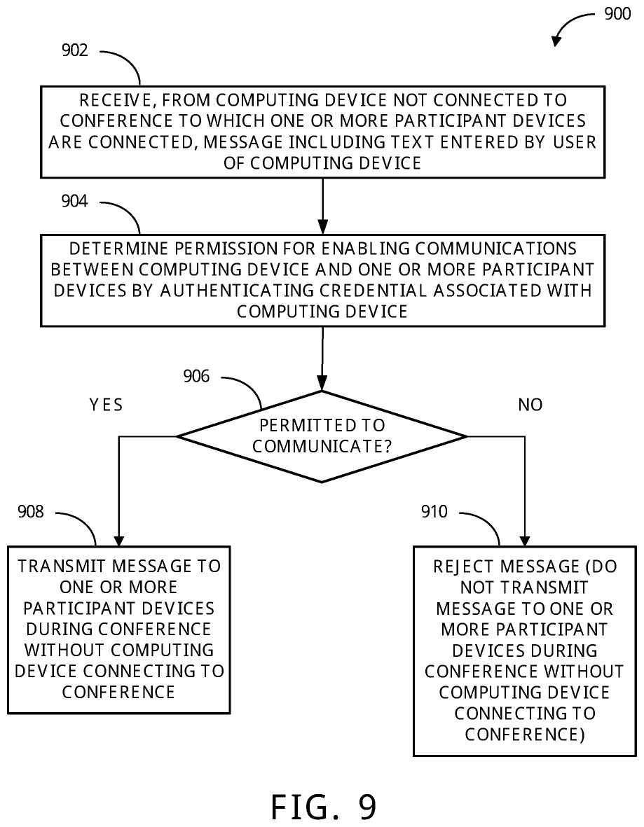

To further describe some implementations in greater detail, reference is next made to examples of techniques which may be performed by or using a system for transmitting a message to one or more participant devices during a conference. FIG. 9 is a flowchart of an example of a technique for transmitting a message. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 902, a server device (e.g., the server device 420) may receive, from a computing device (e.g., the computing device 430A) that is not connected to a conference (e.g., a phone or video conference, such as the conference 402) to which one or more participant devices (e.g., the participant devices 410A and 410B) are connected, a message (e.g., the message 608) including text entered by a user of the computing device. The server device may invoke security software (e.g., server-side security software, such as the other software 318 or the security software 502) to receive the message. For example, the message could be an SMS text message, chat message, email, or calendar invite. The message can be routed from the computing device to the server device, for example, via a phone number or a hyperlink or web address associated with the conference. In some implementations, the message may be dictated by a user of the computing device calling the phone number associated with the conference. The message can then be received by the server device supporting the conference before the computing device joins the conference. The message may include text entered by the user, such as text associated with the SMS text message, chat message, email, or calendar invite.

At 904, the server device may then determine a permission for enabling communications between the computing device and the one or more participant devices by authenticating a credential associated with the computing device. For example, the server device can determine the permission by accessing one or more records stored in a data structure (e.g., the data structure 440) to authenticate the credential associated with the computing device (e.g., a digital credential, such as a phone number, an IP address, or a PIN, or a non-digital credential, such as a driver's license or access card associated with the user). The one or more records could include, for example, calendars, contacts, authorized phone numbers/IP addresses, authorized voice prints, authorized PINs/passwords, and/or authorized images to verify or authenticate the credential. In some implementations, a host device may be configured with a host control for controlling the permissions granted to computing devices during the conference. The host controls may include selectively enabling whether a computing device can transmit a message during the conference, and selectively enabling how a message can be transmitted during the conference.

At 906, the server device can determine whether the computing device is permitted to communicate with the participant devices in the conference without the computing device connecting to the conference. If the computing device is permitted to communicate with the participant devices (e.g., “Yes”), at 908, the server device may transmit the message to the one or more participant devices during the conference without the computing device connecting to the conference. In some implementations, transmitting the message may include the server device may invoke speech synthesis software (e.g., server-side speech synthesis software, such as the other software 318, such as the speech synthesis software 602) during the conference 402 to produce machine-generated speech (e.g., the machine-generated speech 604) representative of the message. For example, the server device may invoke the speech synthesis software to use a spoken voice model (e.g., the voice model 606) of the user of the computing device stored in a data structure (e.g., the data structure 450). The speech synthesis software may use the spoken voice model so that the machine-generated speech sounds like the user speaking to the participants. For example, the spoken voice model may be generated using recorded voice samples of the user (e.g., the recorded voice samples 620), such as from one or more previous conferences and/or using offline training. In some implementations, the server device can also transmit the message, based on the permission, to one or more other computing devices that are not connected to the conference. For example, in addition to transmitting the message to the participant devices that are connected to the conference, the server device can transmit the message to another computing device that is not connected to the conference.

However, at 906, if the computing device is not permitted to communicate with the participant devices (e.g., “No”), at 910, the server device may reject the message (e.g., do not transmit the message to the one or more participant devices during the conference without the computing device connecting to the conference). For example, encryption and/or network security implemented by the security software may be used to protect the conference from unauthorized intrusion by device that is not connected to the conference.

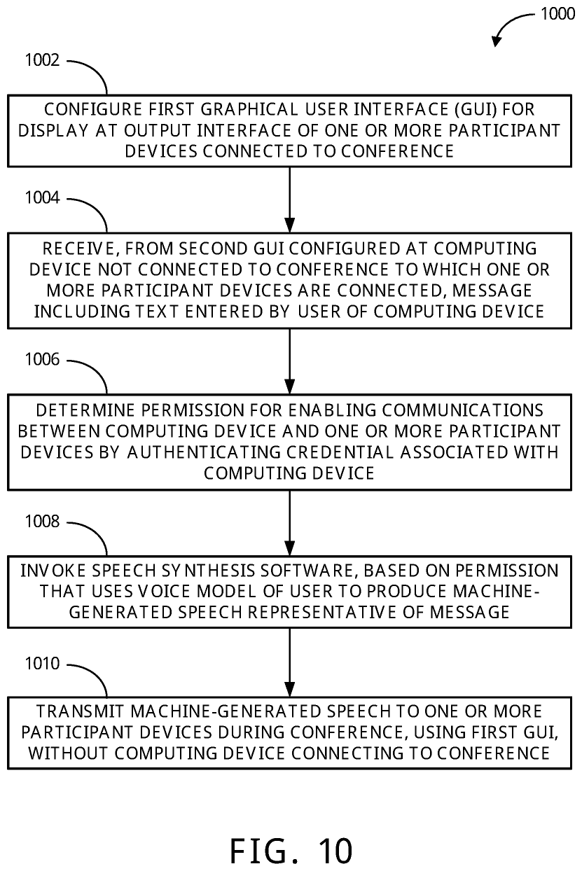

FIG. 10 is a flowchart of an example of a technique for invoking speech synthesis software to transmit a message to one or more participant devices during a conference. The technique 1000 can be executed using computing devices, such as the systems, hardware, and software described with respect to FIGS. 1-8. The technique 1000 can be performed, for example, by executing a machine-readable program or other computer-executable instructions, such as routines, instructions, programs, or other code. The steps, or operations, of the technique 1000 or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1002, a server device (e.g., the server device 420) may configure a first GUI (e.g., the GUI 800) for display at an output interface of one or more participant devices (e.g., the participant devices 410A and 410B) connected to a conference (e.g., a phone or video conference, such as the conference 402). The first GUI could display user tiles associated with participants of the conference (e.g., user tiles 810A and 810B). The first GUI can also prevent the display of user tiles associated with users of computing devices that are not connected to the conference (e.g., users that have not joined the conference). The first GUI may also display a chat area (e.g., the chat area 812). The chat area may enable the participants of the conference to communicate with one another during the conference by sending chat messages.

At 1004, the server device may receive, from a second GUI (e.g., the GUI 700) configured for display at an output interface of a computing device (e.g., the computing device 430A) that is not connected to the conference to which the one or more participant devices are connected, a message (e.g., the message 608) including text, emojis, GIFs, color, or highlight entered by a user of the computing device. For example, the computing device could configure the second GUI for receiving the text, emojis, GIFs, color, or highlight from a user of the computing device and for sending the message to the server device. The server device may invoke security software (e.g., server-side security software, such as the other software 318, or the security software 502) to receive the message. For example, the message could be an SMS text message, chat message, email, or calendar invite. The message can be routed from the computing device to the server device, for example, via a phone number or a hyperlink or web address associated with the conference. In some implementations, the message may be dictated by a user of the computing device calling the phone number associated with the conference. The message can then be received by the server device supporting the conference before the computing device joins the conference. The message may include text entered by the user, such as text associated with the SMS text message, chat message, email, or calendar invite. The message may include the text, emojis, GIFs, color, or highlight entered by the user, such as text associated with the SMS text message, chat message, email, or calendar invite.

At 1006, the server device may then determine a permission for enabling communications between the computing device and the one or more participant devices by authenticating a credential associated with the computing device. For example, the server device can determine the permission by accessing one or more records stored in a data structure (e.g., the data structure 440) to authenticate the credential associated with the computing device (e.g., a digital credential, such as a phone number, an IP address, or a PIN, or a non-digital credential, such as a driver's license or access card associated with the user). The one or more records could include, for example, calendars, contacts, authorized phone numbers/IP addresses, authorized voice prints, authorized PINs/passwords, and/or authorized images to verify or authenticate the credential. In some implementations, a host device may be configured with a host control for controlling the permissions granted to computing devices during the conference. The host controls may include selectively enabling whether a computing device can transmit a message during the conference, and selectively enabling how a message can be transmitted during the conference.

At 1008, the server device may invoke speech synthesis software (e.g., the speech synthesis software 602), based on the permission, to transmit the message. The speech synthesis software can produce machine-generated speech (e.g., the machine-generated speech 604) representative of the message. The speech synthesis software may use a voice model (e.g., the voice model 606) of the user, or selected by the user, to produce the machine-generated speech 604. The voice model may configure the machine-generated speech to sound like the voice of the user or voice chosen by the user (e.g., a cadence, inflection, volume, and/or direction of the speech, such as corresponding to one or more of sound, tone, pitch, phrasing, pacing, and/or accent characteristics) to a human observer, such as by training a machine learning (e.g., the machine learning model 614) to provide such configuration of the voice model. The voice model may configure the machine-generated speech to have a cadence, an inflection, a volume, and/or a directionality based on parameters from an input processing system (e.g., the input processing system 612). As a result, the machine-generated speech may comprise audio representative of the message (e.g., audio representative of the text, emojis, GIFs, color, or highlight, sounding like the user has spoken aloud what the user has submitted via typing).

At 1010, the server device may transmit the machine-generated speech to the one or more participant devices during the conference, using the first GUI at the output interface of the one or more participant devices (e.g., the GUI 800), without the computing device connecting to the conference. The machine-generated speech can be played for the participants of the conference to hear, along with visual indications via the first GUI. In some implementations, the server device may transmit the message by displaying the message, via the first GUI, as a chat message within the conference (e.g., in the chat area 812). In some implementations, an icon (e.g., the icon 816) may be displayed to the first GUI indicating an availability of the message. A participant of the conference can select the icon to access the message during the conference. In some implementations, metadata (e.g., the metadata 818) may be displayed to the first GUI. The metadata could include, for example, geolocation information generated associated with the user sending the message.

Some implementations may include a method that includes receiving, from a computing device that is not connected to a conference to which one or more participant devices are connected, a message including text entered by a user of the computing device; determining a permission for enabling communications between the computing device and the one or more participant devices by authenticating a credential associated with the computing device; and transmitting, based on the permission, the message to the one or more participant devices during the conference. In some implementations, transmitting the message includes invoking speech synthesis software during the conference to produce machine-generated speech representative of the message, the speech synthesis software using a spoken voice model of the user that is generated using recorded voice samples of the user to produce the machine-generated speech. In some implementations, determining the permission includes accessing a record including at least one of authorized phone numbers or authorized IP addresses; and comparing at least one of a phone number or an IP address associated with the computing device to the authorized phone numbers or authorized IP addresses in the record. In some implementations, determining the permission includes verifying a personal identification number associated with at least one of the message or the computing device. In some implementations, determining the permission includes authenticating at least one of a spoken voice of the user or a keyword spoken by the user. In some implementations, the permission is selectively enabled by a host device of the one or more participant devices connected to the conference. In some implementations, the method may include detecting at least one of a color or a highlight of at least a portion of the text; and producing machine-generated speech representative of the message, wherein at least a portion of the machine-generated speech changes inflection based on the color or the highlight. In some implementations, the message is communicated as a chat message within the conference. In some implementations, a GUI for the conference includes an icon indicating an availability of the message. In some implementations, the method may include determining a second permission for enabling communications between a second computing device and the one or more participant devices by authenticating a second credential associated with the second computing device; and transmitting, based on the second permission, the message to the second computing device during the conference without the second computing device connecting to the conference. In some implementations, the method may include delivering the message, based on the permission, to a first participant device of the one or more participant devices without delivering the message to a second participant device of the one or more participant devices. In some implementations, the message is transmitted with metadata generated by the computing device.

Some implementations may include an apparatus that includes a memory and a processor. The processor may be configured to execute instructions stored in the memory to receive, from a computing device that is not connected to a conference to which one or more participant devices are connected, a message including text entered by a user of the computing device; determine a permission for enabling communications between the computing device and the one or more participant devices by authenticating a credential associated with the computing device; and transmit, based on the permission, the message to the one or more participant devices during the conference. In some implementations, the processor is further configured to execute instructions stored in the memory to receive an input from a host device of the one or more participant devices connected to the conference, wherein the input controls the permission. In some implementations, the processor is further configured to execute instructions stored in the memory to limit transmission of the message to a first particular participant of one or more participants. In some implementations, the message is transmitted with geolocation information generated by the computing device.

Some implementations may include a non-transitory computer readable medium that stores instructions operable to cause one or more processors to perform operations that include receiving, from a computing device that is not connected to a conference to which one or more participant devices are connected, a message including text entered by a user of the computing device; determining a permission for enabling communications between the computing device and the one or more participant devices by authenticating a credential associated with the computing device; and transmitting, based on the permission, the message to the one or more participant devices during the conference. In some implementations, the operations further include using a machine learning model that is trained using recorded voice samples of the user to configure a spoken voice model of the user; and invoking speech synthesis software during the conference to produce machine-generated speech representative of the message, the speech synthesis software using the spoken voice model of the user. In some implementations, the operations further include receiving the message from at least one of a wearable electronic device used by the user or a virtual reality device used by the user. In some implementations, the operations further include transmitting the message to a first participant device of the one or more participant devices as a private message directed to the first participant.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, from a computing device that is not connected to a conference to which one or more participant devices are connected, a message including text entered by a user of the computing device;
determining a permission for enabling communications between the computing device and the one or more participant devices by authenticating a credential associated with the computing device; and
transmitting, based on the permission, the message to the one or more participant devices during the conference.

2. The method of claim 1, wherein transmitting the message includes:
invoking speech synthesis software during the conference to produce machine-generated speech representative of the message, the speech synthesis software using a spoken voice model of the user that is generated using recorded voice samples of the user to produce the machine-generated speech.

3. The method of claim 1, wherein determining the permission includes:
accessing a record including at least one of authorized phone numbers or authorized Internet Protocol (IP) addresses; and
comparing at least one of a phone number or an IP address associated with the computing device to the authorized phone numbers or authorized IP addresses in the record.

4. The method of claim 1, wherein determining the permission includes:
verifying a personal identification number associated with at least one of the message or the computing device.

5. The method of claim 1, wherein determining the permission includes:
authenticating at least one of a spoken voice of the user or a keyword spoken by the user.

6. The method of claim 1, wherein the permission is selectively enabled by a host device of the one or more participant devices connected to the conference.

7. The method of claim 1, further comprising:
detecting at least one of a color or a highlight of at least a portion of the text; and
producing machine-generated speech representative of the message, wherein at least a portion of the machine-generated speech changes inflection based on the color or the highlight.

8. The method of claim 1, wherein the message is communicated as a chat message within the conference.

9. The method of claim 1, wherein a graphical user interface for the conference includes an icon indicating an availability of the message.

10. The method of claim 1, further comprising:
determining a second permission for enabling communications between a second computing device and the one or more participant devices by authenticating a second credential associated with the second computing device; and
transmitting, based on the second permission, the message to the second computing device during the conference without the second computing device connecting to the conference.

11. The method of claim 1, further comprising:
delivering the message, based on the permission, to a first participant device of the one or more participant devices without delivering the message to a second participant device of the one or more participant devices.

12. The method of claim 1, wherein the message is transmitted with metadata generated by the computing device.

13. An apparatus, comprising:
a memory; and
a processor configured to execute instructions stored in the memory to:
receive, from a computing device that is not connected to a conference to which one or more participant devices are connected, a message including text entered by a user of the computing device;
determine a permission for enabling communications between the computing device and the one or more participant devices by authenticating a credential associated with the computing device; and
transmit, based on the permission, the message to the one or more participant devices during the conference.

14. The apparatus of claim 13, the processor is further configured to execute instructions stored in the memory to:
receive an input from a host device of the one or more participant devices connected to the conference, wherein the input controls the permission.

15. The apparatus of claim 13, the processor is further configured to execute instructions stored in the memory to:
limit transmission of the message to a first particular participant of one or more participants.

16. The apparatus of claim 13, wherein the message is transmitted with geolocation information generated by the computing device.

17. A non-transitory computer readable medium storing instructions operable to cause one or more processors to perform operations comprising:
receiving, from a computing device that is not connected to a conference to which one or more participant devices are connected, a message including text entered by a user of the computing device;
determining a permission for enabling communications between the computing device and the one or more participant devices by authenticating a credential associated with the computing device; and
transmitting, based on the permission, the message to the one or more participant devices during the conference.

18. The non-transitory computer readable medium storing instructions of claim 17, the operations further comprising:
using a machine learning model that is trained using recorded voice samples of the user to configure a spoken voice model of the user; and
invoking speech synthesis software during the conference to produce machine-generated speech representative of the message, the speech synthesis software using the spoken voice model of the user.

19. The non-transitory computer readable medium storing instructions of claim 17, the operations further comprising:
receiving the message from at least one of a wearable electronic device used by the user or a virtual reality device used by the user.

20. The non-transitory computer readable medium storing instructions of claim 17, the operations further comprising
transmitting the message to a first participant device of the one or more participant devices as a private message directed to the first participant.
